(19) United States
(12) Patent Application Publication
(10) Pub. No.: US 2004/0209769 A1
(43) Pub. Date: Oct. 21, 2004

(54) Redox-catalyst for selective catalytic reduction and method for the production thereof

(76) Inventors: Yvonne Demel, Frankfurt (DE); Thomas Kreuzer, Karben (DE); Egbert Lox, Grebenhain (DE); Adolf Schafer-Sindlinger, Frankfurt (DE); Paul Spurk, Bad Konig (DE); Hans Van Den Tillaart, Brockhuizenvorst (NL)

Correspondence Address: KALOW & SPRINGUT LLP, 488 MADISON AVENUE, 19TH FLOOR, NEW YORK, NY, 10022, US

(21) Appl. No.: 10/480,351

(22) PCT Filed: Jun. 7, 2002
(86) PCT No.: PCT/EP02/06266

(30) Foreign Application Priority Data
Jun. 9, 2001 (EP) 01114096.9

(51) Int. Cl. B01J 27/051

(52) U.S. Cl. 502/220

(57) ABSTRACT

The invention provides a redox catalyst for the selective reduction of the nitrogen oxides present in exhaust gas from diesel engines using ammonia. The reduction catalyst contains a catalytically active material which is based on the solid acid system TiO₂/WO₃/MoO₃V₂O₅/SiO₂/SO₃ and an oxidation catalyst based on the platinum group metals platinum and palladium. The reduction catalyst is present in the form of a cylindrical honeycomb catalyst with an inlet and an outlet end face. The oxidation catalyst is applied to a section of the reduction catalyst adjacent to the outlet end face. The redox catalyst is characterised in that the catalytically active material in the reduction catalyst is used as support material for the platinum group metals in the oxidation catalyst.

The invention provides a redox catalyst for the selective reduction of the nitrogen oxides present in exhaust gas from diesel engines using ammonia, containing a reduction catalyst in which the catalytically active material is based on the solid acid system TiO₂/WO₃/MoO₃/V₂O₅/SiO₂/SO₃ and an oxidation catalyst based on the platinum group metals platinum and palladium, wherein the reduction catalyst is provided in the form of a cylindrical honeycomb catalyst with an inlet and an outlet end face and the oxidation catalyst is applied to a section of the reduction catalyst adjacent to the outlet end face.

The process for selective catalytic reduction is called the SCR (Selective Catalytic Reduction) process in the following. According to the SCR process, the nitrogen oxides in oxygen-containing exhaust gas from a diesel engine is selectively reduced with ammonia on a reduction catalyst (SCR catalyst). The process was developed for steady state exhaust gas treatment and has been successfully applied for many years to the purification of fumes from power stations and block-type thermal power stations.

Ammonia is extremely difficult to use in the mobile sector due to its properties. Therefore, ammonia is not used directly here, but is obtained from an ammonia donor compound such as, for example, urea. For this purpose, urea is decomposed, either thermally or using a urea hydrolysis catalyst, to give ammonia which is reacted with nitrogen to form water and nitrogen oxides on the reduction catalyst. For the present invention, the source of the ammonia is of no consequence. Whenever the wording metered addition of ammonia is used in the following, this also includes appropriate measures for the metered addition and decomposition of urea.

The SCR process enables a reduction in the amount of nitrogen oxides in the exhaust gas from diesel engines of more than 70%. One problem associated with the SCR process is the precise metered addition of ammonia. The currently disclosed metering systems for ammonia include controlled and uncontrolled systems. Controlling the addition of ammonia is performed, for example, on the basis of data obtained in the engine characteristics sector.

In driving mode, overaddition can take place very easily and this leads to undesired emissions of ammonia to the environment (ammonia leakage). This behaviour is moderated in that a SCR catalyst usually has a certain storage capacity for ammonia. Under some conditions, however, undesired emissions cannot be completely avoided. Therefore it has been disclosed that a so-called ammonia barrier catalyst be connected downstream of the SCR catalyst. This is an oxidation catalyst which oxidises ammonia to water and nitrogen and thus suppresses the undesired emissions. In addition, this oxidation catalyst also oxidises the hydrocarbons and carbon monoxide present in the exhaust gas.

The catalysts used are usually cylindrical, monolithic catalysts which are penetrated by flow channels for the exhaust gas which run from an inlet end face to an outlet end face and are parallel to the axis. They are also called honeycomb catalysts. They may be designed as so-called full catalysts or as coating catalysts. Full catalysts consist completely of catalytically active material and are obtained by extrusion of the catalytically active material to form honeycomb structures. Their cell density (number of flow channels per area of cross-section) is relatively low and is generally less than 5 cm⁻². In the case of so-called coating catalysts, however, the catalytically active material is applied in the form of a thin coating (about 10 to 100 μm thick) on inert support structures made of ceramic or metal. The inert support structures are generally also constructed in the form of monolithic honeycomb structures. Their cell density is substantially higher than that of full catalysts. Support structures with cell densities of 62 cm⁻² are in normal use. Support structures with cell densities up to 300 cm⁻² are under development.

EP 0 615 777 A1, describes an exhaust gas converter which is suitable for the selective catalytic reduction of nitrogen oxides. It contains, in the direction of flow of the exhaust gas, first a device for adding urea, a urea hydrolysis catalyst, a SCR catalyst and finally an oxidation catalyst located immediately downstream of these. U.S. Pat. No. 5,628,186 also describes this type of system. In both cases, the SCR catalyst and the oxidation catalyst are separate structures which have to be separately supported in the exhaust gas treatment converter. The costs for one exhaust gas treatment converter consisting of two separate catalyst structures are relatively high. In addition, the exhaust gas counter pressure, and thus the fuel consumption, is increased by the second catalyst structure.

EP 0 410 440 B1 describes another possibility. According to this document, the oxidation catalyst is applied as a coating to the outflow section of the one-piece reduction catalyst which is designed as a full extrudate in a honeycomb shape, wherein the region coated with oxidation catalyst makes up 20 to 50% of the entire catalyst volume. The oxidation catalyst contains, as catalytically active component, at least one of the platinum group metals platinum, palladium and rhodium, which are deposited on cerium oxide, zirconium oxide and aluminium oxide as support materials.

The combined reduction/oxidation catalyst (redox catalyst) in accordance with EP 0 410 440 B1 has the advantage, as compared with using separate reduction and oxidation catalysts, that the cost of supporting the catalyst can be kept low. However, the necessity for an additional coating on a section in the outflowing region of the reduction catalyst presents a problem, in particular with catalysts with a high cell density, because the coating increases the exhaust gas counter pressure and flow channels may become blocked during the coating procedure.

Thus, the object of the present invention is to provide a one-piece redox catalyst which does not have the disadvantages of the redox catalyst in EP 0 410 440 B1 and is particularly simple to prepare.

This object is achieved by a redox catalyst for the selective catalytic reduction of the nitrogen oxides present in exhaust gas from diesel engines using ammonia, which contains a reduction catalyst in which the catalytically active material is based on the solid acid system TiO₂/WO₃/MoO₃/V₂O₅/SiO₂/SO₃ and an oxidation catalyst based on the platinum group metals platinum and palladium, wherein the reduction catalyst is present in the form of a cylindrical honeycomb catalyst with a length L and with an inlet and an outlet end face and the oxidation catalyst is applied to a section of the reduction catalyst adjacent to the outlet end face. The catalyst is characterised in that the catalytically active material in the reduction catalyst is used as a support material for the platinum group metals in the oxidation catalyst.

In contrast to EP 0 410 440 B1, the catalytically active components are not applied to separate support materials such as, for example, aluminium oxide, but are incorporated directly in an outflow section of the reduction catalyst. The catalytically active material in the reduction catalyst is thus used as a support material for the catalytically active platinum group metals. According to the invention, separate coating of the reduction catalyst with support materials for the platinum group metals can be omitted.

The region of the reduction catalyst coated with oxidation catalyst is used as an ammonia barrier catalyst. Ammonia which is not consumed during selective catalytic reduction to give nitrogen and water according to the reaction equation

2NH₃+1.5O₂→N₂+3H₂O

is oxidised on the oxidation catalyst. So that the oxidation reaction proceeds as completely as possible, it has proven expedient to choose the length of reduction catalyst coated with oxidation catalyst to be between 5 and 20%. Too small a length leads to incomplete oxidation of the ammonia, so ammonia may still break through, whereas with too great a length of oxidation catalyst the risk of superoxidation of the ammonia to give dinitrogen oxide (laughing gas) increases.

A full catalyst which contains a mixture of solid acids such as TiO₂/WO₃/MoO₃/V₂O₅/SiO₂/SO₃ as catalytically active materials may be used as the basis for the redox catalyst. Preferably, however, a reduction catalyst in the form of a coating on an inert support structure made of ceramic or metal is used as the basis for the redox catalyst. This embodiment permits the use of support structures with high cell densities, such as are also used for conventional three-way converters.

To impregnate the outflow section of the reduction catalyst with platinum group metals, the outlet end face of the catalyst is dipped into an impregnating solution which contains dissolved precursor compounds of the platinum group metals. After impregnation, the catalyst is dried and calcined. Before the redox catalyst according to the invention can be obtained by this method, however, considerable difficulties have to be overcome because it has been shown that the catalytic activity of the reduction catalyst is greatly damaged by contamination with platinum. Only by complying with certain conditions during impregnation can the introduction of platinum metals in the outflow section of the reduction catalyst be prevented from damaging the reduction activity of the catalyst.

The most important measure to mention is the choice of suitable precursor substances when impregnating with platinum group metals. It has been shown that only neutral or basic impregnation solutions lead to successful results. Tables 1 and 2 give the pHs of some platinum and palladium impregnation solutions:

TABLE 1
Platinum solutions

| Platinum | Platinum concentration | pH of |
|---|---|---|
| precursor | in the impregnation | impregnation |
| compound | solution [wt. %] | solution |
| H₂PtCl₆ · 6H₂O | 0.89 | 1.13 |
| [Pt(NH₃)₄](NO₃)₂ | 0.89 | 7.10 |
| (EA)₂Pt(OH)₆⁸⁾ | 0.89 | 9.72 |
| [Pt(NH₃)₄](OH)₂ | 0.89 | 12.81 |

^{*)}(HO—C₂H₄—NH₃)₂Pt(OH)₆: Ethanolammoniumplatinum (IV) hexahydroxide

TABLE 2
Palladium solutions

| Palladium | Palladium concentration | pH of |
|---|---|---|
| precursor | in the impregnation | impregnation |
| compound | solution [wt. %] | solution |
| Pd(NO₃)₂ | 0.49 | 1.26 |
| Pd(NH₃)₂(NO₂)₂ | 0.49 | 8.45 |
| [Pd(NH₃)₄](NO₃)₂ | 0.49 | 9.26 |

From among these aqueous noble metal solutions, only those with a pH greater than 6 to 7 are suitable. It has been shown that acid impregnation solutions spread very rapidly over the entire reduction catalyst, due to the porosity of the catalytically active material in the reduction catalyst, even when only a short section at the outlet end face is dipped into the impregnation solution. Only neutral or basic impregnation solutions are very rapidly fixed to the reduction catalyst and produce a relatively sharp separation line between the two sections of the catalyst.

In addition, there is an active capillary effect due to the limited diameter of the flow channels, in particular in catalysts with a high cell density. As a result of an incorrect impregnation procedure, the solution can reach a large part of the reduction catalyst by suction due to the capillary forces in the flow channels. This is the case no matter what particular impregnation solution is used, and thus even when basic impregnation solutions are used. The resulting redox catalysts are then useless.

This capillary effect can be prevented by dissolving the precursor compounds for the platinum group metals in only a limited volume of solvent. A solvent volume which corresponds to 70 to 100% of the water take-up capacity of the section of reduction catalyst to be impregnated with oxidation catalyst has proven beneficial. In addition, it has proven beneficial to reduce the surface tension of the impregnation solution by using a surfactant.

As an alternative to the aqueous impregnation solutions described here, organic solutions of platinum compounds may also be used for impregnating. Suitable organic solvents are, for example, toluene, alcohols and tetrahydrofuran.

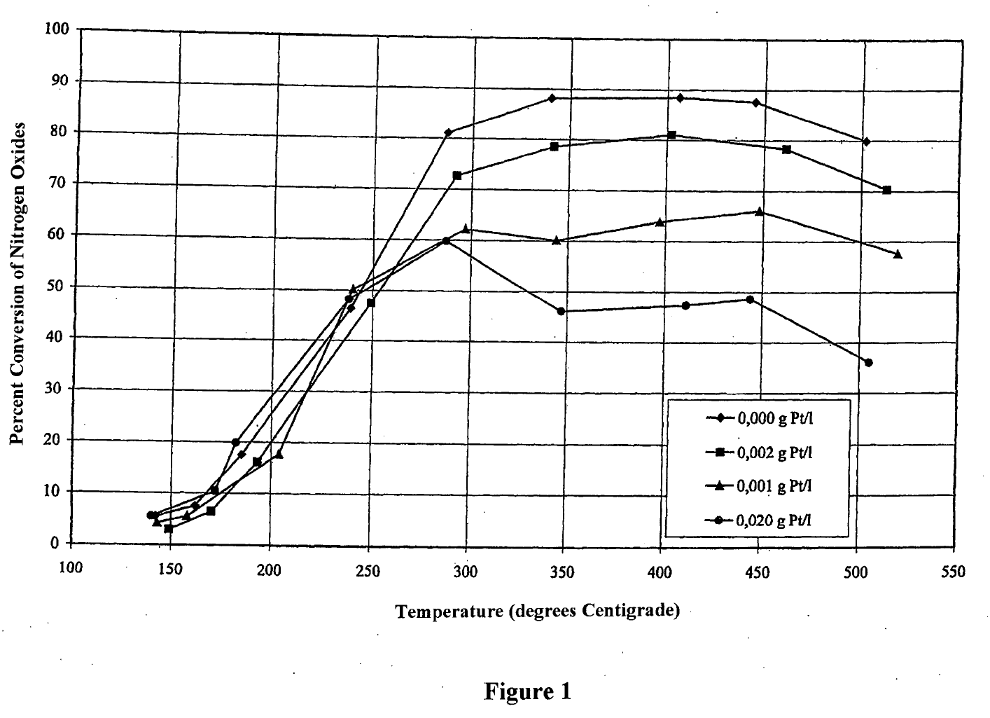

The invention is now explained with reference to some examples and FIGS. 1 to 4 (sic). These show:

FIG. 1: Nitrogen oxide conversions of SCR catalysts with different platinum contamination, as a function of gas temperature.

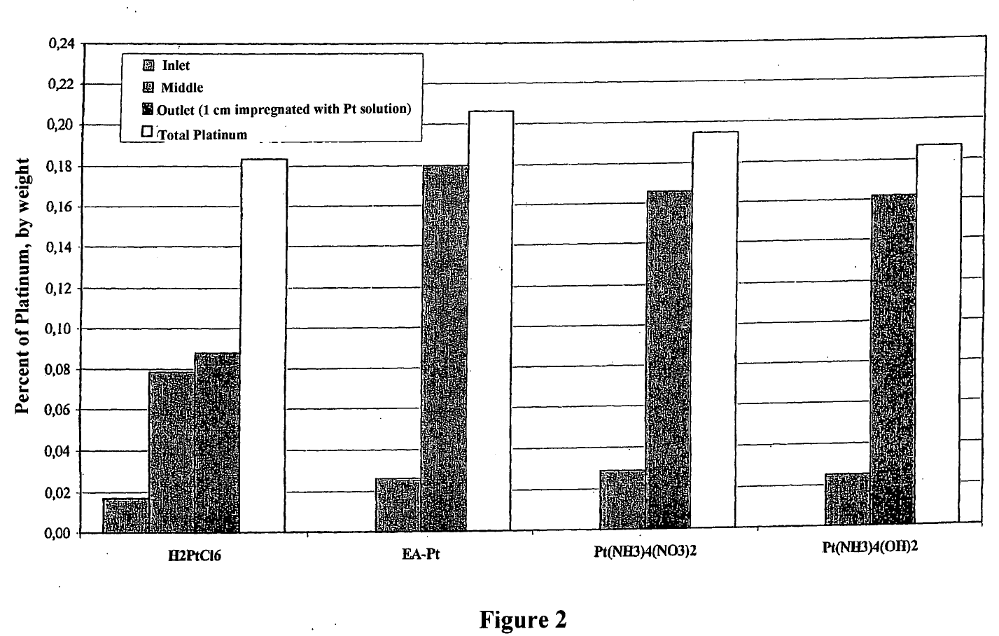

FIG. 2: The effect of different platinum impregnation solutions on axial platinum distribution in the redox catalyst

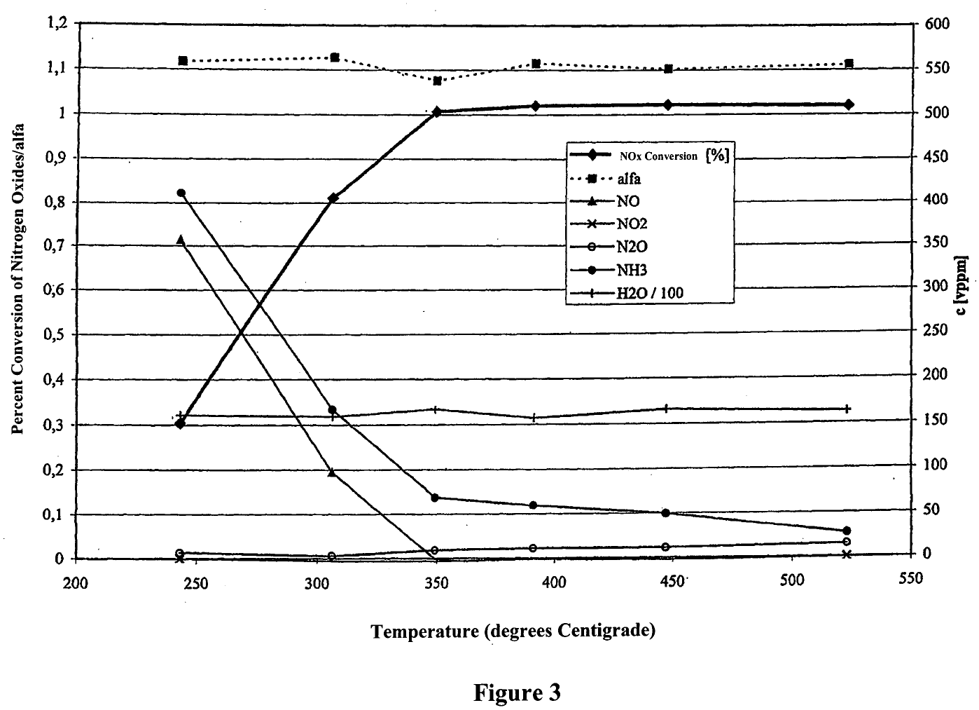

FIG. 3: Nitrogen oxide conversions of a SCR catalyst, as a function of gas temperature

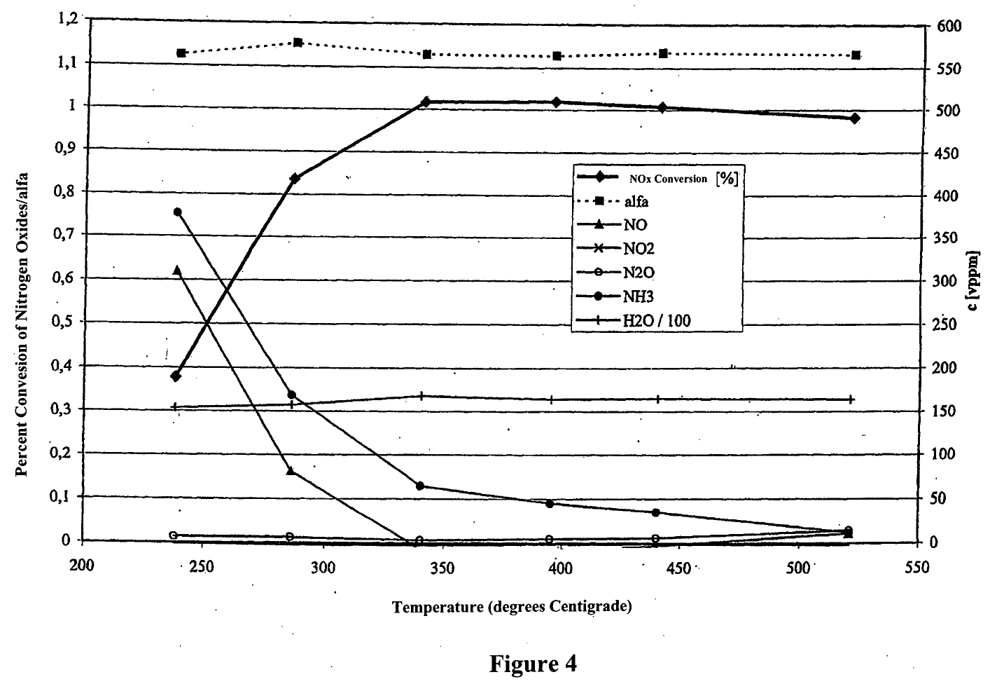

FIG. 4: Nitrogen oxide conversions of a redox catalyst with palladium, according to the invention

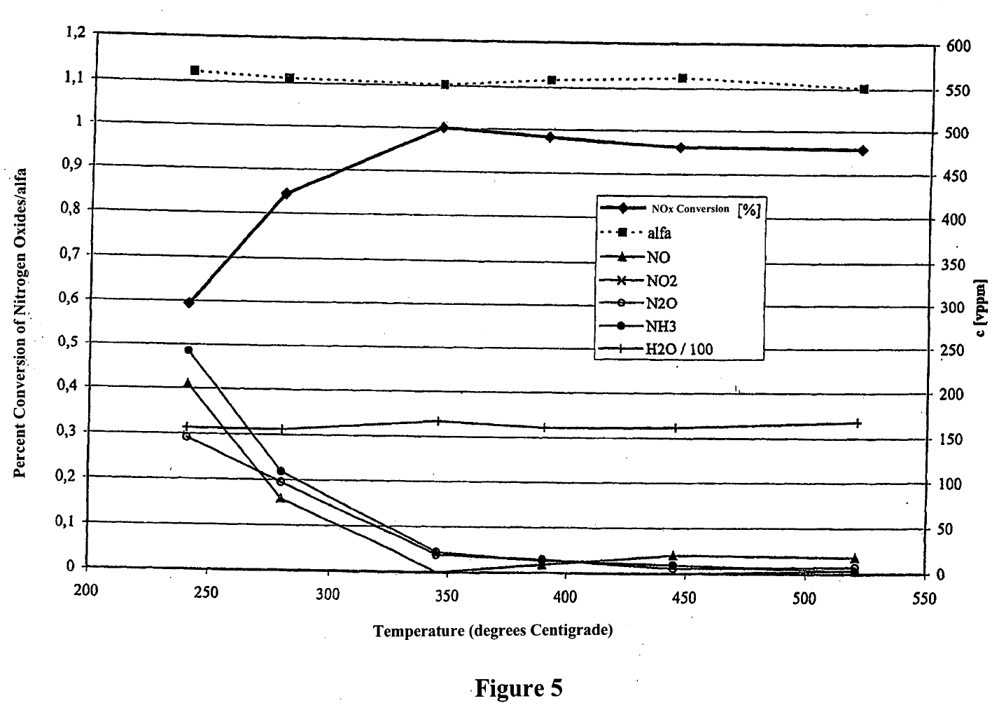

FIG. 5: Nitrogen oxide conversions of redox catalyst with platinum, according to the invention

### EXAMPLE 1

Effect of Platinum Contamination on the Reduction Activity of a SCR Catalyst:

The effect of contamination of a conventional SCR catalyst with different platinum concentrations was studied. Four different platinum concentrations were used: 0.0, 0.002, 0.01 and 0.02 g platinum per litre of catalyst structure (g/l).

To prepare the SCR catalysts, an aqueous coating suspension with a solids content of 40 wt.-% was made up. The suspension contained, with respect to dry weight, 80 wt. % or titanium dioxide in the anatase modification with a specific surface area of 80 m²/g and 20 wt. % γ-aluminium oxide with a specific surface area of 140 m²/g. This was divided into four portions. Increasing amounts of a platinum catalyst were added to the four portions of coating suspension (platinum on γ-aluminium oxide), so that the concentrations given above were present in the final catalysts.

Then four honeycomb structures made of cordierite with a cell density of 62 cm⁻² and a volume of 0.0386 litres (Ø:25.4 mm, length: 76.2 mm) were coated by immersion in each of the four coating suspensions, then dried at 120° C. in a stream of air and calcined in air at 500° C. for one hour. The coating concentration applied each time in this way (reduction layer) was 180 g/l of honeycomb structure.

In a further step, the coated honeycomb structures were coated with 2.5 wt. % V₂O₅ and 13 wt. % WO₃, each with respect to the weight of catalyst coating. For this purpose, the honeycomb structures were impregnated with a solution of the precursor compounds vanadyl oxalate and ammonium metatungstate. Decomposition of the impregnated oxide precursors was performed in a stream of air at 600° C. for one hour, after air-drying at 120° C. This concluded preparation of the SCR reduction catalyst.

The catalytic properties of these catalysts were measured as a function of exhaust gas temperature in a model gas unit supplied with a synthetic diesel exhaust gas. The synthetic exhaust gas had the following composition:

TABLE 3
Exhaust gas composition

| Gas component | Concentration |
|---|---|
| NO | 500 vol. ppm |
| NH₃ | 450 vol. ppm |
| O₂ | 5.0 vol. % |
| H₂O | 1.3 vol. % |
| N₂ | remainder |

The so-called alpha value (molar ratio NH₃/NOₓ) of this gas mixture was 0.9. On the basis of this substoichiometric composition, a maximum nitrogen conversion of 0.9 would be expected. In contrast to real diesel exhaust gas, the synthetic gas mixture did not contain any hydrocarbons, sulfur dioxide, carbon dioxide or soot particles.

The synthetic exhaust gas was passed over the catalyst with a space velocity of 30000 h⁻¹. The rates of conversion of the catalysts were measured at decreasing exhaust gas temperatures between 500 and 150° C., in order to minimise the effect of ammonia storage by the SCR catalyst. Between 500 and 200° C., the exhaust gas temperature was decreased in 50° C. steps, between 200 and 150° C. in 25° C. steps.

FIG. 1 shows the degrees of conversion for nitrogen oxides measured on the four catalysts. It is obvious that only the catalyst without platinum contamination (0.000 g/W) achieves the expected degree of conversion of almost 90%. Even with very low platinum concentrations of only 0.002 g/l the maximum nitrogen oxide conversion is lowered by 8%.

### EXAMPLE 2

Four more honeycomb structures were coated with the SCR catalyst in example 1 without platinum contamination. Then the outlet end faces of the honeycomb structures were each dipped in different platinum impregnation solutions in order thus to produce, at the outlet side of the catalyst structure, an oxidation activity for ammonia which has not been consumed by the SCR coating.

For this purpose, first of all the water-take-up of the entire catalyst structure was determined and from that was calculated the amount of water which the catalyst structure would take up over 13% of the total length, corresponding to 1 cm. The water take-up was 8.5 g for a volume of catalyst structure of 0.0386 litres. A few drops of a commercially available surfactant were added to the impregnation solution to reduce the surface tension.

Four impregnation solutions with the four platinum compounds in table 1 were prepared. The amounts of platinum compounds used were selected so that they corresponded to the expected concentration of 1.41 g/l Pt (40 g/ft.³) in the region of the oxidation catalyst. The calculated amount of the platinum compounds was weighed into a vessel with a flat base and filled up to the previously calculated volume with water.

The honeycomb structures were dipped into the impregnation solutions until these solutions had been full absorbed. Then the catalysts were dried in a blower at 120° C. Care was taken to ensure that the part of the catalyst impregnated with noble metal was on the outlet side of the blower in order to avoid contamination of the non-impregnated part of the reduction catalyst with platinum.

Then the catalysts were calcined in an oven at 500° C. for a period of two hours.

The redox catalysts prepared in this way were each cut into three equal sections, each with a length of 25.4 mm, milled and compressed to form tablets. The platinum concentration in these tablets was determined using X-ray fluorescence analysis. The results are shown in FIG. 2. The redox catalyst impregnated with H₂PtCl₆ has an obvious platinum concentration in the inlet third, although the amount of liquid in the impregnation solution had been calculated for impregnating only the last 10 mm of the catalyst structure. There was no platinum, within the limits of accuracy of the analytical method, in the inlet third of the three other catalyst structures, which had been impregnated with the neutral or basic platinum solutions in table 1. Only the middle third of these catalyst structures had a similar platinum concentration to that in the inlet third of the first catalyst structure.

### EXAMPLE 3

A further SCR catalyst without platinum contamination, as in example 1, was prepared on a honeycomb structure.

The catalytic properties of this catalyst were measured in the same way as in example 1. The alpha value, however, was adjusted to 1.1 in order to produce ammonia leakage. The measurements were performed at a space velocity of 30000 h⁻¹. The experimental results are shown graphically in FIG. 3. In addition to the conversion curve for nitrogen oxides, the diagram also shows the alpha value of the synthetic gas mixture and the gas concentrations of NO, NO₂, N₂O, NH₃ and water vapour in volume ppm (vppm). As a result of this superstoichiometric proportion of ammonia in the synthetic gas, a clear leakage of unconsumed ammonia occurs even at high gas temperatures. The production of laughing gas (N₂O) is low.

### EXAMPLE 4

A redox catalyst according to the invention was prepared with palladium as oxidation catalyst. For this purpose, a pure SCR catalysts as in example 1 was impregnated with palladium to a length of 0.5 cm at the outlet end face. The palladium concentration on this section of the catalyst was 1.41 grams per litre of honeycomb structure.

The catalyst was measured in the same way as in example 3. The experimental results are shown in FIG. 4. The redox catalyst with palladium has a somewhat reduced ammonia leakage as compared with the pure SCR catalyst from example 3. The production of laughing gas is negligible, which means that the catalyst has a high selectivity.

### EXAMPLE 5

Example 4 was repeated, but the palladium was replaced by platinum. The experimental results are shown in FIG. 5. This redox catalyst exhibits substantially reduced ammonia leakage. However, this is at the expense of a slightly greater production of laughing gas, especially in the lower temperature region.

1. A redox catalyst for the selective catalytic reduction of the nitrogen oxides contained in exhaust gas from diesel engines using ammonia, containing a reduction catalyst in which catalytically active materials are based on We a solid acid system having TiO₂/WO₃/MoO₃/V₂O₅/SiO₂/SO₃, and an oxidation catalyst based on the platinum group of metals platinum and palladium, wherein the reduction catalyst is present in the form of a cylindrical honeycomb structure with length L and with a gas inlet and a gas outlet end face and the oxidation catalyst is applied to a section of the reduction catalyst which is adjacent to the outlet end face, and wherein the catalytically active materials in the reduction catalyst are used as support materials for the platinum group metals of the oxidation catalyst.

2. A redox catalyst according to claim 1, wherein the oxidation catalyst is applied from the gas outlet end face and extends 1 to 20% of the length L of the reduction catalyst.

3. A redox catalyst according to claim 2, wherein the reduction catalyst is present in the form of a monolithic full catalyst.

4. A redox catalyst according to claim 2, wherein the reduction catalyst is present in the form of a catalytically active coating on an inert, monolithic honeycomb structure made from ceramic or metal.

5. A process for preparing a redox catalyst according to claim 3, comprising:
the applying the oxidation catalyst to a reduction catalyst by impregnating the outlet end face of the reduction catalyst with an aqueous, neutral or basic impregnation solution of compounds of the platinum group metals, and drying and calcining the redox catalyst.

6. A process according to claim 5, wherein the reduction catalyst has a water take-up capacity, and wherein the compounds of platinum group metals are dissolved in a volume of solvent which corresponds to 70 to 80% of the water take-up capacity of the section of reduction catalyst to be impregnated with oxidation catalyst.

7. A process according to claim 6, wherein the surface tension of the impregnation solution is reduced by adding surfactants.

8. A process for preparing a redox catalyst according to claim 3, wherein the oxidation catalyst is applied to the reduction catalyst by impregnation of at least the outlet end face of the reduction catalyst with an organic impregnation solution of compounds of the platinum group metals, and drying and calcining the redox catalyst.

9. A process according to claim 8, wherein the reduction catalyst has a solvent take-up capacity, and wherein the compounds of platinum group metals are dissolved in a volume of solvent which corresponds to 70 to 100% of the solvent take-up capacity of the section of reduction catalyst to be impregnated with the oxidation catalyst.

10. A process according to claim 9, wherein the surface tension of the impregnation solution is reduced by adding surfactants.

11. A process for preparing a redox catalyst according to claim 4, comprising:
applying the oxidation catalyst to a reduction catalyst by impregnating the outlet end face of the reduction catalyst with an aqueous, neutral or basic impregnation solution of compounds of the platinum group metals, and drying and calcining the redox catalyst.

12. A process for preparing a redox catalyst according to claim 4, comprising:
applying the oxidation catalyst to a reduction catalyst by impregnation of the outlet end face of the reduction catalyst with an organic impregnation solution of compounds of the platinum group metals, and drying and calcining the redox catalyst.
